(19) United States
(12) Patent Application Publication
(10) Pub. No.: US 2025/0274959 A1
(43) Pub. Date: Aug. 28, 2025

(54) UTILIZING MULTIPLE RESOURCE POOLS FOR SIDELINK POSITIONING

(71) Applicant: Nokia Technologies Oy, Espoo (FI)

(72) Inventors: Taylan SAHIN, Munich (DE); Stepan KUCERA, Munich (DE); Berthold PANZNER, Munich (DE); Diomidis MICHALOPOULOS, Munich (DE); Torsten WILDSCHEK, Gloucester (GB)

(21) Appl. No.: 18/859,517

(22) PCT Filed: Apr. 29, 2022
(86) PCT No.: PCT/EP2022/061525

§ 371 Date: Oct. 23, 2024

(51) Int. Cl. H04W 72/40; H04L 5/00

(52) U.S. Cl. CPC H04W 72/40; H04L 5/0051

(57) ABSTRACT

The disclosure inter alia relates to a first terminal device configured for sidelink communication in a first sidelink resource pool, the first terminal device comprising means for—receiving resource pool information related to a second sidelink resource pool configured for a second terminal device; —transmitting, via sidelink communication, a request to the second terminal device to reserve resources in the second sidelink resource pool for transmission, by the first terminal device, of a sidelink positioning reference signal:—receiving, via sidelink communication, a response to the request from the second terminal device; and—based on the response, transmitting a sidelink positioning reference signal using resources in the first sidelink resource pool and resources in the second sidelink resource pool.

### TECHNOLOGICAL FIELD

The present disclosure is related to but not limited to communication networks as defined by the 3GPP standard, such as the 5G standard, also referred to as New Radio, NR. The disclosure in particular pertains to sidelink positioning and more particular to sidelink positioning via sidelink positioning reference signals.

### BACKGROUND

The present disclosure relates to sidelink positioning, as for instance discuses in the technical report [1].Compared to existing positioning methods over the Uu interface, sidelink (SL) positioning has the advantage of operating outside (or partial) network coverage, in addition to in-coverage conditions, where network-based positioning is not applicable or not able to satisfy positioning QoS requirements (e.g., due to fewer anchor nodes available), or when user equipments (UEs) are beyond the reach of GNSS coverage (e.g., in tunnels). SL positioning will be an enabler of many use cases, as described in [2], most prominently public safety and road safety, and many vehicular applications including traffic efficiency, coordinated driving, and autonomous driving, as well as industrial applications.

To do positioning over the SL radio interface, UEs need to transmit/receive certain reference signals for positioning, which are referred to as SL positioning reference signals (SL PRS). UEs conduct certain measurements (e.g. time of arrival, angle of arrival, etc.) on these refence signals, which are then used to calculate their position estimates.

Presently, SL utilizes certain parts of a dedicated or shared frequency band, so called bandwidth parts (BWP). Within a bandwidth part, SL transmissions and receptions take place over resource pools that are (pre-) configured by the network. As illustrated in the exemplary time-frequency diagram of FIG. 1, a SL BWP uses a certain part of the total carrier bandwidth. In the SL BWP resource pools are reserved for SL communication over a resource pool period. A resource pool in turn spans L frequency sub-channels, each having Msub physical resource blocks PRBs, and a certain number of time slots. The configured resource pools use a single numerology. While SL resource pools are configured separately for SL transmission and reception, different pools may overlap in time and/or frequency. As per the current specifications, UEs are allowed to transmit and receive only using the resource pools they are (pre-) configured with.

According to the current 3GPP specifications (mainly TS 38.331), sidelink UEs use a certain bandwidth part “s1-BWP” (maxNrofSL-BWPs-r16=4) configured by the network, with a certain numerology. The s1-BWP contains one or more resource pools that can generally have different size, i.e., having different number of frequency subchannels and time slots. In general, the network may (pre-) configure the resource pools to be either perfectly orthogonal or to have at least partial or even full overlap. Each resource pool is (pre-) configured for a set of UEs for either transmitting (Tx), or receiving (Rx), or both, over the SL interface.

An example is given in FIG. 2. UE1 is configured with the same pool for SL transmission (Tx1) and reception (Rx1). It is also the case for UE3 (Tx3 and Rx3), UE2, on the other hand, is configured with different pools for transmission (Tx2) and reception (Rx2). It receives over a much larger Rx resource pool, which also overlaps with transmission and reception pools of other UE1 and UE3.

A SL UE is permitted to transmit and receive only on Tx/Rx SL resource pool(s) to which it is specifically configured with. According to TS38.331 section 5.8.7, a sidelink UE determines the configured SL resource pool to transmit/receive in the following order: first it uses the Tx/Rx pools indicated in a RRC Reconfiguration message (transmitted via dedicated signaling), if possible. Else, the UE uses the Tx/Rx pools indicated in SIB12 (transmitted via broadcast), if possible. Else, the UE uses the Tx/Rx pools indicated in SL-PreconfigurationNR (preconfigured in the UE).

When in mode 2 (autonomous resource allocation mode), the UE shall perform sensing on all pools of resources which may be used for transmission of the sidelink control information and the corresponding sidelink data. The resource pools are as indicated by preconfiguration, SIB12 or RRCreconfiguration as mentioned above.

### SUMMARY OF SOME EXEMPLARY EMBODIMENTS

However there is the problem, that in 5G and beyond networks, applications have very demanding positioning requirements for sidelink, mainly in terms of accuracy and latency (see e.g. [1]).

In order to achieve high-accuracy positioning (see e.g., the fundamental Cramer-Rao bound), the positioning reference signals—measured in terms of time/angle/phase to estimate UE position—should be transmitted/received over relatively large bandwidths, ideally at the order of higher 10 s or even 100 s of MHz. However, the resource pools configured for SL transmissions and receptions have smaller bandwidth typically, which is insufficient for any practically meaningful positioning. The current Rel-16 resource pool configuration for NR sidelink limits the maximum number of PRBs to a maximum of 275, which equates to a total allowed frequency bandwidth of 49.5 MHz.

Moreover, bandwidth parts allocated for SL are much smaller as compared to uplink/downlink (UL/DL) Uu bands, e.g., 30 MHz out of the ITS (Intelligent Transport Systems) frequency band at 5.9 GHz is dedicated for vehicular SL communications. So while UL/DL-based positioning could theoretically benefit from few hundreds MHz of bandwidth available, the practical limitation on the size of sidelink resource pools as well as SL bandwidth parts significantly restrict the usable transmission of wideband reference signals required for accurate positioning over SL interface. The problem is thus the limited bandwidth or resources available for SL positioning, thereby limiting the achievable positioning accuracy.

In NR Sidelink Rel-16 and Rel-17, sidelink resource reservation is performed by sidelink control information (SCI). The SCI is carried over the physical sidelink control channel (PSCCH) and split into a 1st stage SCI and a 2nd stage SCI. SCI configuration for NR-Sidelink is specified in 3GPP 38,212 Section 8.4. The 1st stage SCI contains the resource reservation/allocation (frequency granularity in subchannels, time granularity in slots) for up to three future sidelink transmission opportunities.

The problem is that in Rel-16 and Rel-17 there is a unique 1:1 (i.e., bijective) mapping between a SCI and the sidelink resource reservation(s). In other words, it is not possible in NR Sidelink Rel-16 and Rel-17 to aggregate multiple SCI for the same reservation, i.e., for each sidelink resource reservation there is exactly one and only one SCI. Hence, a wideband resource reservation that may span over multiple resource pools (adjacent, partially or fully overlapping) in order to maximize sidelink bandwidth (e.g., for the purpose of Rel-18 NR Sidelink positioning) is not possible with the single-SCI framework of NR Sidelink Rel-16/Rel-17.

While there are techniques to utilize wider frequency bandwidth or resources available in the network, such as carrier aggregation (see for instance [4] and [5]), for communication purposes. However, such techniques involve significant centralized coordination by the network, use only UL/DL bands, or in case of SL, the carrier aggregation solutions so far only target SL communication. For example, specific radio link measurements, RRC management over single carrier component, asymmetric scheduling and replication of HARQ sublayer are required, e.g., to overcome issues around diverse coverage of individual carrier components.

Thus, certain embodiments of the disclosure may have the effect of providing an improved sidelink positioning. More specifically, certain embodiments may achieve high accuracy positioning in SL scenarios by taking advantage of all available sidelink resources in the network but not necessarily (pre-) configured to individual UEs. Further, certain embodiments of the disclosure may have the effect of allowing multiple resource aggregation for SL positioning, while avoiding complex arrangements. More specifically, certain embodiments of the disclosure may have the effect of providing a simple yet efficient method for allowing a UE to make use of multiple resource pools or bandwidth parts for SL positioning with minimal or no network coordination, i.e. providing a scheme which is distributed while preserving inherent reliability.

According to a first exemplary aspect, there is disclosed a first terminal device configured for sidelink communication in a first sidelink resource pool. The first terminal device may comprise means for receiving resource pool information related to a second sidelink resource pool configured for a second terminal device.

The first terminal device may further comprise means for transmitting, via sidelink communication, a request to the second terminal device to reserve resources in the second sidelink resource pool for transmission, by the first terminal device, of a sidelink positioning reference signal. The first terminal device may further comprise means for receiving, via sidelink communication, a response to the request from the second terminal device. The first terminal device may further comprise means for, based on the response, transmitting a sidelink positioning reference signal using resources in the first sidelink resource pool and resources in the second sidelink resource pool.

According to a second exemplary aspect, there is disclosed a second terminal device configured for sidelink communication in a second sidelink resource pool. The second terminal device may comprise means for receiving via sidelink communication, from a first terminal device configured for sidelink communication in a first sidelink resource pool, a request to reserve resources in the second sidelink resource pool for transmission, by the first terminal device, of a sidelink positioning reference signal. The second terminal device may further comprise means for transmitting via sidelink communication, to the first terminal device, a response to the request. The second terminal device may further comprise means for reserving, in response to the request, resources in the second sidelink resource pool for transmission, by the first terminal device, of a sidelink positioning reference signal.

According to a third exemplary aspect, there is disclosed a network entity, the network entity comprising means for transmitting or causing transmitting, to a first terminal device, resource pool information related to sidelink resource pools configured for one or more other terminal devices served by respective other base stations.

According to each of the exemplary aspects, a respective method is also disclosed.

Thus, according to the first exemplary aspect, there is a method, performed by a first terminal device configured for sidelink communication in a first sidelink resource pool. The method may comprise receiving resource pool information related to a second sidelink resource pool configured for a second terminal device. The method may further comprise transmitting, via sidelink communication, a request to the second terminal device to reserve resources in the second sidelink resource pool for transmission, by the first terminal device, of a sidelink positioning reference signal. The method may further comprise receiving, via sidelink communication, a response to the request from the second terminal device. The method may further comprise, based on the response, transmitting a sidelink positioning reference signal using resources in the first sidelink resource pool and resources in the second sidelink resource pool.

According to the second exemplary aspect, there is disclosed a method, performed by a second terminal device configured for sidelink communication in a second sidelink resource pool. The method may comprise receiving via sidelink communication, from a first terminal device configured for sidelink communication in a first sidelink resource pool, a request to reserve resources in the second sidelink resource pool for transmission, by the first terminal device, of a sidelink positioning reference signal. The method may further comprise transmitting via sidelink communication, to the first terminal device, a response to the request. The method may further comprise reserving, in response to the request, resources in the second sidelink resource pool for transmission, by the first terminal device, of a sidelink positioning reference signal.

According to the third exemplary aspect, there is disclosed a method, performed by a network entity, the method comprising transmitting or causing transmitting, to a first terminal device, resource pool information related to sidelink resource pools configured for one or more other terminal devices served by respective other base stations.

Any of the disclosed device (terminal device, network entity) may be stationary device or a mobile device. The terminal device may in particular be a user equipment, e.g. mobile device, such as a smartphone, a tablet, a wearable, a smartwatch, a low power device, an IoT device, an IIoT device, a vehicle, a truck, a drone, an airplane, or the like. The terminal device (e.g. the first terminal device) may in particular be capable of communicating with (transmitting and receiving signals and/or data to/from) one or more other terminal devices (e.g. one or more second terminal devices) and/or a network device, such as a base station of a communication network. Generally, the terminal device may also be any device enabled for communication with a communication network and/or another terminal device.

A network device may be understood as a wireless communication station installed at a fixed or mobile location and may in particular be or comprise an entity of the radio access network of the communication system. For instance, the network device may be, comprise, or be part of a base station of a communication network of any generation (e.g. a gNB, eNodeB, NodeB, BTS or the like) of 3GPP standard. Generally, the network device may be or comprise a hardware or software component implementing a certain functionality. For instance, in an example, the network device may be a location management function, LMF. In an example, the network device may be an entity as defined by 3GPP 5G or NR standard (also referred to as gNB). Accordingly, while the network device may be understood to be implemented in or be a single device or module, the network device may also be implemented across or comprise multiple devices or modules. As such, the network device may in particular be implemented in or be a stationary device. Multiple network devices of the exemplary aspect may in particular establish a communication system or network, which may in particular be a New Radio (NR) or 5G system (5GS) or any other mobile communications system defined by a past or future standard, in particular successors of the present 3GPP standards. The network device of the exemplary aspects may be capable of being in direct and/or indirect communication with the exemplary terminal device.

The means or functionality of any of the disclosed devices or apparatuses (i.e. any of the terminal devices and network devices) can be implemented in hardware and/or software. They may comprise one or multiple modules or units providing the respective functionality. They may for instance comprise at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

Thus, according to the respective exemplary aspects of the present disclosure, there is in each case also disclosed a respective apparatus (i.e. a terminal device and a network device) comprising at least one processor and at least one memory including computer program code, the at least one memory and the computer program code configured to, with the at least one processor, cause an apparatus at least to perform a method according to the respective aspect of the present disclosure.

Any of the above-disclosed exemplary aspects may, however, in general be performed by an apparatus, which may be a module or a component for a device, for example a chip. The disclosed apparatus may comprise the disclosed components, for instance means, processor, memory, or may further comprise one or more additional components.

According to the exemplary aspects of the present disclosure, there is in each case also disclosed a computer program, the computer program when executed by a processor of an apparatus causing said apparatus to perform a method according to the respective aspect.

The computer program may in each case be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

The first and second terminal device may be in certain proximity to each other, such that a direct communication via sidelink, i.e. without a base station, is possible. The first and second terminal device may be served by the same or different cells and/or base stations, or may be out of coverage (i.e. temporarily not served by any base station). It is noted, that while the example embodiments provided herein are described with respect a second terminal device, the first terminal device may of course be in sidelink communication with various other terminal devices, which may be referred to multiple second terminal devices, or a second, third, fourth and so forth terminal device. Accordingly, the first terminal device may then perform the described actions with respect to multiple second terminal devices. For instance, the first terminal device may receive resource pool information related to multiple second sidelink resource pools configured for respective multiple second terminal devices and transmit a respective request to each or at least some of these multiple second terminal devices. The first terminal device may then also receive respective responses from one or more of these multiple second terminal devices. For instance, one or more second terminal devices may be able to reserve resources as requested, and one or more second terminal devices may not be able to reserve resource as requested. Based on these one or more responses, the sidelink positioning reference signal may then be transmitted using resources in the first sidelink resource pool and resources in one or more of the respective second resource pools.

The described aspects can achieve a high accuracy positioning in SL scenarios by taking advantage of more sidelink resources in the network but not necessarily (pre-) configured to individual UEs. Thus, a bandwidth extension can be achieved and, in particular, a terminal device can transmit a wideband reference signal for sidelink positioning (wideband SL PRS) spanning over not only the first sidelink resource pool of the first terminal device, but potentially also over one or more other sidelink resource pools of one or more second terminal devices. Thus, an inter-pool coordination of resource allocation for a wideband SL PRS transmission is achieved.

This provides two advantages. By dynamically requesting and reserving resources of the allocated resource pools of the terminal devices, it can be avoided to configure a separate or dedicated SL resource pool just for SL PRS transmissions. Since SL PRS transmissions usually takes place only occasionally, such a separate SL resources pool would result in wastage of the (semi-) statically reserved resources in this separately configured resource pool. In addition, it can be avoided that the terminal devices have to constantly monitor all configured SL resource pools in the network in order to transmit a wideband SL PRS signal spanning across multiple resource pools. Such monitoring would create heavy energy consumption, or would simply not be possible by certain types of terminal devices, e.g., with reduced SL and/or battery capability.

As will be explained in more detail below, the resource pool information may in particular be obtained from the network, such as via dedicated signaling (e.g. via the DL RRC Reconfiguration message). In this way, the network can inform the first terminal device about the sidelink resource pools configured for other, second sidelink terminal devices (which may be served by respective other base stations), so as to allow the first terminal device to transmit a wideband reference signal for sidelink positioning utilizing the sidelink resources of the second terminal devices. Otherwise a terminal device could not know the pool configuration of other terminal devices. In contrast, the suggested approach allows for an inter-and intra-resource pool coordination for resource reservation and allocation.

For this, as described with respect to the third exemplary aspect, a network entity may be provided for transmitting the resource pool information related to sidelink resource pools configured for one or more other terminal devices (not being in the same sidelink resource pool as the first terminal device) to the first terminal device. In an example, the network entity may be or comprise a centralized network controller gathering and/or distributing resource pool information related to sidelink resource pools managed by multiple serving base stations. Alternatively, the network entity may be or comprise a base station configured for coordinating with one or more other base stations with respect to the sidelink resource pools configured or to be configured by the respective base stations. Thus, the base station may not only provide the first terminal device with information about its first sidelink resource pool, but also with information about one or more second sidelink resource pools of respective one or more second terminal devices (which may be served by another base station). For instance, the base stations may inform each other of resources they have configured for respective sidelink resource pools.

By transmitting a request as described, a terminal device can request other terminal devices in other resource pools, e.g. by sending a SL control information (such as SCI, as will be described in more detail below), for them to reserve resources for the requesting UE to transmit wideband SL PRS transmission. This is different from the known SCI usage, which is sent from a terminal device to reserve resources for its own SL transmission only, and transmitted only using its own SL transmission resource pool. Accordingly, the proposed SCI is not required to contain information regarding any reserved resources, but indicates a request for other UEs to make resource reservation.

Correspondingly, the respective second terminal devices may then reserve resource in their respective second sidelink resource pools, if available. For instance, a respective second terminal device may transmit control information in its resource pool (e.g. a SCI) for reserving resources for the SL PRS transmission. This is also different from the known concept of where an SCI is sent from a terminal device to reserve resources for its own SL transmission only. As will be described in more detail below, specifically the transmission of control information by the second terminal device may enable legacy terminal devices using the same pool to avoid selecting the resources to be reserved for SL PRS transmission.

The second terminal devices in the respective second resource pools can then respond to the requesting first terminal device. For instance, in case resources are available at the respective second terminal device, the respective second terminal device may reserve resources in the respective second sidelink resource pool and may send a positive response indicating that resources are reserved as requested. For instance, in case resources are not available at the respective second terminal device, the respective second terminal device may not reserve resource in the respective second sidelink resource pool and may send a negative response. As will be explained in more detail below, for the response, the second terminal devices may use the resources reserved by the requesting terminal device in the resource pool of the requesting first terminal device. In contrast to the known concepts, a terminal device can only reserve resources for its own SL transmission.

Depending on respective responses from respective second terminal devices, the first terminal can determine the final resources available for transmitting a positioning reference signal. For instance, the terminal device may transmit multiple control information messages (such as SCI messages) staggered across the frequency domain in respective second resource pools (for which it was indicated by respective second terminal devices that resources are reserved) in order to perform a wideband SL PRS transmission. In contrast to the conventional 1-to-1 mapping between an SCI and the associated SL transmission, the proposed approach allows for utilizing multiple control messages (such as SCI messages) to reserve and indicate resources for a single wideband SL PRS transmission across multiple SL resource pools. As will be explained in more detail below, different resource pools may be non-contiguous or there may be an overlap between different resource pools in the time and/or frequency domain. In the latter case, a respective control message of the SL PRS may be transmitted at the first (lowest) subchannel of the overlapping part. If there is no overlap, SCI is transmitted for each pool, for instance using the first subchannel.

Since the first terminal device has received resource pool information related to a second sidelink resource pool, the request can be transmitted based on the received resource pool information. For instance, the first terminal device may be aware of the Rx resources of the second resource pool of the second terminal device so that the first terminal device may transmit the request in such Rx resources of the second resource pool. In case there is an overlap between the resources of the first and second resource pool (e.g. between the TX resources of the first resource pool and the RX resources of the second resource pool), the first terminal device may preferably use such overlapping resources for transmitting the request to the respective second terminal device.

For instance, the request may be transmitted (and received) in a physical sidelink control channel, PSCCH. In one example, the request may be transmitted (and received) in a control information message, such as a sidelink control information (SCI) message. In one example, an information field of a sidelink control information message may be provided for sending the request. The field may not have an associated data payload, so that in this case the first terminal device may not indicate any specific resources to be reserved or any resources to be used for the response by the second terminal device. In one example, the request is transmitted (and received) in a physical sidelink shared channel or in a data payload associated with a sidelink control information message. This allows for indicating or providing further information to the second terminal device, such as specific resources to be reserved or resources to be used for the response by the second terminal device. For instance, the request may be transmitted (and received) in resources overlapping between the first sidelink resource pool and the second sidelink resource pool. As the first terminal device usually already monitors this overlapping part, this has the advantage of avoiding resource collisions. Even in case there is no overlap, the request may still be transmitted (and received) in the second sidelink resource pool. For instance, the first terminal device may randomly select the resources in the respective second sidelink resource pool.

In one example, the request comprises information representative of an amount of resources in the second sidelink resource pool requested to be reserved. Additionally or alternatively, the request may comprise information representative of (specific) resources in the second sidelink resource pool requested to be reserved. Additionally or alternatively, the request may comprise information representative of resources in the first sidelink resource pool reserved by the first terminal device to be used by the second terminal device for responding to the request, which avoids resource collisions for the response of the second terminal device.

For this the first terminal device may announce in the first pool the resources reserved for the response, e.g. by sending a control message, such as an SCI message. The request may also comprise information representative of transmission parameters to be used by the second terminal device for responding to the request.

The first terminal device may comprise means for reserving resources in the first resource pool to be used by the second terminal device for responding to the request. As described above, the first terminal device may for instance announce in the first pool the resources reserved for the response, e.g. by sending a control message, such as an SCI message. These reserved resources may then be indicated to the second terminal device. e.g.

with the request as described above.

The first terminal device comprises means for determining, based on the response, resources for transmitting the sidelink positioning reference signal. For instance, the first terminal device may determine overlaps or gaps between the different second sidelink resource pools, in which resources have been reserved for the SL PRS transmission. For instance, the first terminal device may determine, based on the resources that have been reserved for the SL PRS transmission, the final set of resources that will be used for the transmission of the SL PRS by the first device. Based thereon, the first terminal device may determine the control messages to be used for transmitting the SL PRS.

The response may include information regarding the resources in the second sidelink resource pool for transmission, by the first terminal device, of the sidelink positioning reference signal.

For instance, the response may indicate that the specific resources requested by the first terminal device are available, e.g. by means of an acknowledgement (ACK) message. Accordingly, the response may comprise an acknowledgement of resources in the second sidelink resource pool requested to be reserved by the first terminal device with the request.

For instance, the response may indicate that the specific resources requested by the first terminal device are not available, e.g. by means of a negative acknowledgement (NACK) message. For this, the response may comprise a negative acknowledgement of resources in the second sidelink resource pool requested to be reserved by the first terminal device with the request.

For instance, the response may indicate specific resources that have been reserved by the second terminal, e.g. in case the first terminal device did not request any specific resources or in case the resources requested by the first terminal device are not available. For this, the response may comprise information representative of resources in the second sidelink resource pool reserved by the second terminal device for the transmission of the sidelink positioning reference signal.

The response may not necessarily be an explicit response, but it may also be implicit or implied. For instance, the second terminal may only send an (explicit) response and first terminal device may only expect an (explicit) response in case of an acknowledgement. In case no response is received by the first terminal device, this is interpreted as an implicit negative acknowledgement. Alternatively, the second terminal may only send an (explicit) response and first terminal device may only expect an (explicit) response in case of a negative acknowledgement. In case no response is received by the first terminal device, this is interpreted as an implicit acknowledgement. As can be seen in these scenarios, the second terminal device may not necessarily transmit, to the first terminal device, a response to the request and the first terminal device may not necessarily receive a response to the request from the second terminal device.

Similarly as described above with respect to the request, the response may be (transmitted and) received in resources overlapping between the first sidelink resource pool and the second sidelink resource pool, which avoids resource collisions, as the overlapping part is already monitored.

Nevertheless, the response may generally be (transmitted and) received in (any non-overlapping) resources in the first sidelink resource pool, in particular in case that there are no overlapping parts. For instance, resources in the first sidelink resource pool may be reserved by the first terminal device to be used by the second terminal device for responding to the request. For instance, the response may be (transmitted and) received in resources of a physical sidelink feedback channel or a data payload associated with a sidelink control information message used by the first terminal device for reserving resources in the first sidelink resource pool.

In an example, the response may be (transmitted and) received in a response message or data payload associated with a (new) sidelink control information message transmitted by the second terminal device. In an example, the sidelink control information message comprises information representative of transmission parameters (pertaining to time and/or frequency resources and/or the modulation coding scheme, for instance) used by the second terminal device for the response.

The response may be (transmitted and) received in resources in the second sidelink resource pool, in particular in case the first terminal device did not indicate any resources reserved for the response (e.g. in the first resource pool). For this, the first UE may start monitoring the second sidelink resource pool. In an example, the response may be (transmitted and) received in resources of a physical sidelink feedback channel associated with a sidelink control information message comprising or associated with the request transmitted by the first terminal device in the second sidelink resource pool.

In a further alternative, the response may be (transmitted and) received in a separate or new sidelink transmission.

The resource pool information may be received from (and transmitted by) the network via dedicated signaling, in particular via RRC signaling, for instance in a RRC Reconfiguration message. Alternatively, the resource pool information may be received and transmitted via a broadcast message, in particular using a system information block, SIB, such as SIB12. The resource pool information may be transmitted by the network to the first terminal device either unsolicited or upon request of the first terminal device.

The first terminal device may comprise means for receiving, from the network, information on overlaps between configured resource pools. This information may be determined by the network and then transmitted to the first terminal device (and usually to all other terminal device it is serving). Thus, the network may comprise corresponding means for transmitting. Alternatively, the information on overlaps may also be determined be the first terminal device itself.

The first terminal device may comprise means for receiving, from the network, information on whether a sidelink position reference signal transmission is allowed in resources outside of configured resource pools. Thus, the network may comprise corresponding means for transmitting respective information. If transmission resources outside of configured resource pools is allowed, the first terminal device is able to send a SL PRS substantially over the whole carrier bandwidth, even when the resource pools do not cover or not contiguously cover the whole carrier bandwidth. If transmission in resources outside of configured resource pools is not allowed, the first terminal device may still transmit a non-contiguous SL PRS in case the resource pools are non-contiguously spread over the carrier bandwidth. If transmission in resources outside of configured resource pools is not allowed and the resource pools are also not spread over the carrier bandwidth (neither contiguously nor non-contiguously), a wideband SL PRS transmission may not be possible (at least none that covers the whole substantially carrier bandwidth).

For transmitting the sidelink positioning reference signal, the first terminal device may transmit multiple control information messages, in particular sidelink control information messages. The control information messages may indicate the scheduled resources across the multiple pools for transmitting the SL PRS via control messages associated with the wideband SL PRS. For instance, one control information message per sidelink resource pool may be used. However, in case resource pools overlap, one single control information message may be transmitted in the overlapping resources, as described below. While the multiple control information messages may be transmitted in different frequency resources, they may be transmitted in the same time resource.

In case the first sidelink resource pool and the second sidelink resource pool overlap in the time and frequency domain, a control information message for the sidelink positioning reference signal is transmitted in resources overlapping between the first sidelink resource pool and the second sidelink resource pool. For instance, a control information messages may be transmitted in a predefined (e.g. first or lowest) sub-channel of the overlapping resources of the resource pool.

The sidelink positioning reference signal may substantially cover the bandwidth of the first sidelink resource pool and the second sidelink resource pool. For instance, the sidelink positioning reference signal may substantially cover the bandwidth of the first sidelink resource pool and of multiple second sidelink resource pools. For instance, the sidelink positioning reference signal may substantially cover the whole carrier bandwidth (e.g. contiguously, or non-contiguously).

The sidelink positioning reference signal may cover resources in the frequency domain outside of the first and second sidelink resource pools. As described above, the network may provide information to the first terminal that a sidelink position reference signal transmission is allowed in resources outside of configured resource pools. The first terminal device is then able to send a SL PRS substantially over the whole carrier bandwidth, even when the resource pools do not cover or not contiguously cover the whole carrier bandwidth.

The resources in the second sidelink resource pool for transmission, by the first terminal device, of sidelink positioning reference signal may be reserved after an expiry of a timer. The timer may be a random timer. The second terminal device may reserve respective resources by sending a control information message, such as a SCI, in its second resource pool. This lets the other (legacy and non-legacy) terminal devices in the second resource pool know that the second terminal device has reserved the respective resources. In particularly, the legacy terminal device can then refrain from using the reserved resources. The other (non-legacy) terminal devices in the second sidelink resource pool will then know that the second terminal device will respond to the request of the first terminal device and they can refrain from doing the same. The other (non-legacy) terminal devices in the second sidelink resource pool may also confirm to the second terminal that they will not respond to the request.

It is to be understood that the presentation of the embodiments disclosed herein is merely by way of examples and non-limiting.

Herein, the disclosure of a method step shall also be considered as a disclosure of means for performing the respective method step. Likewise, the disclosure of means for performing a method step shall also be considered as a disclosure of the method step itself.

Other features of the present disclosure will become apparent from the following detailed description considered in conjunction with the accompanying drawings. It is to be understood, however, that the drawings are designed solely for purposes of illustration and not as a definition of the limits of the present disclosure, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 shows an exemplary embodiment of a sidelink resource pool in a time frequency diagram;

FIG. 2 shows an exemplary arrangement of different sidelink resource pools in a time frequency diagram;

FIG. 3 shows a schematic diagram illustrating an example radio environment in which exemplary embodiments of the present disclosure may be performed;

FIGS. 4a, b shows sidelink resource pools of a first and second UE in a time frequency diagram illustrating an example embodiment of the different aspects;

FIGS. 5a, b shows sidelink resource pools of a first, a second and a third UE in a time frequency diagram illustrating an example embodiment of the different aspects;

FIG. 6a, b illustrates contiguously and non-contiguously configured resource pools in the time frequency domain:

FIG. 7 shows an exemplary decision tree for determining how to transmit a wideband SL PRS;

FIG. 8a,b,c show an exemplary signaling flow chart;

FIG. 9 shows an exemplary signaling flow chart;

FIG. 10 shows a schematic diagram illustrating a block diagram of an exemplary embodiment of an apparatus according to the present disclosure;

FIG. 11 shows a block diagram of an exemplary embodiment of a base station; and

FIG. 12 shows a schematic illustration of examples of tangible and non-transitory computer-readable storage media.

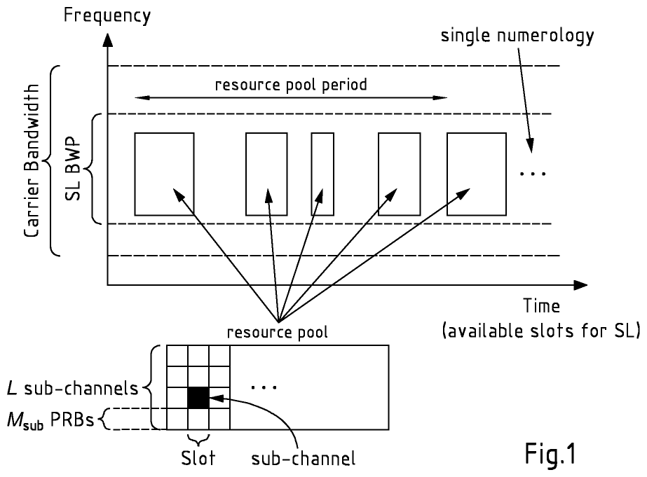

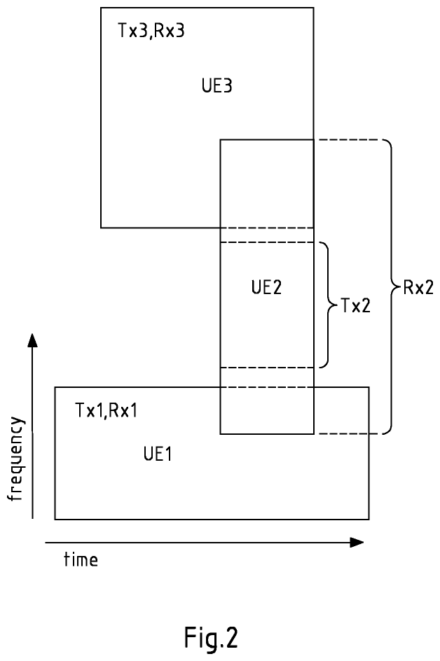

### DETAILED DESCRIPTION OF THE FIGURES

The following description serves to deepen the understanding of the present disclosure and shall be understood to complement and be read together with the description of example embodiments of the present disclosure as provided in the above SUMMARY section of this specification.

In the following an, an example communication system, in which the present disclosure may be applied, is described. While the specific radio system in the examples below is a 5G system, this is only to be considered a non-limiting example.

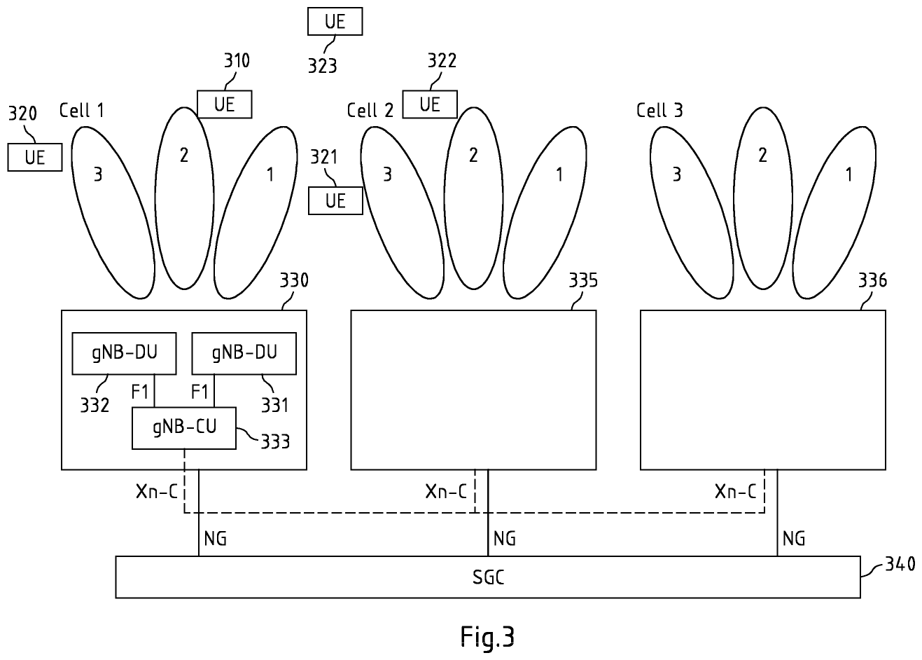

FIG. 3 shows a 5G communication network, which introduces the New Radio technology and also an architecture for which the different sublayers of the RAN may be split into two logical entities in a communication network control element (like a BS or gNB), which are referred to as distributed unit (DU) and central unit (CU). For example, the CU is a logical node that controls the operation of one or more DUs over a front-haul interface (referred to as F1 interface). The DU is a logical node including a subset of the gNB functions, depending on the functional split option.

As shown in FIG. 3, a first user equipment (UE) 310, as an example of a first terminal device of the exemplary aspects of the present disclosure, is connected to a cell 1 of a network device or base station, a gNB 320 via a communication beam of the cell 1. In the example shown in FIG. 3, the gNB 330 is provided with a CU 333 and two DUs 331 and 332 being connected to the CU 333 by a F1 interface. Furthermore, as shown in the example of FIG. 3, there is a plurality of further cells to which the first UE 310 can connect. Naturally, in each cell, a plurality of UEs may be present and connected to the respective cell. Similarly to cell 1, cells 2 and 3 are controlled by gNB 25 and 26, respectively, and each provides a plurality of beams 1 to 3, which may be used for beam diversity or beam hopping. A plurality of second UEs 320, 321, 322, 323 as examples of a second terminal device according to the different aspects of the invention is shown, which may be connected to the same or different base stations. A UE, such as currently UE 323, may also be outside of the network coverage. Nevertheless, the first UE 310 is still able to communicate directly with the second UEs 320, 321, 322, 323 via sidelink communication without the need of the respective base stations. As shown in FIG. 3, each base station or gNB of the cells is connected to a core network, such as a 5GC, via respective interfaces, indicated as NG interfaces. Furthermore, each gNB of the cells is connected with each other by means of a specific interface, which is referred to e.g. as an Xn-C interface. Any of these network entities, such as the gNB, gNB-DU, gNB-CU and/or 5GC, may individually or together be an example of a base station or a part thereof according to the present disclosure.

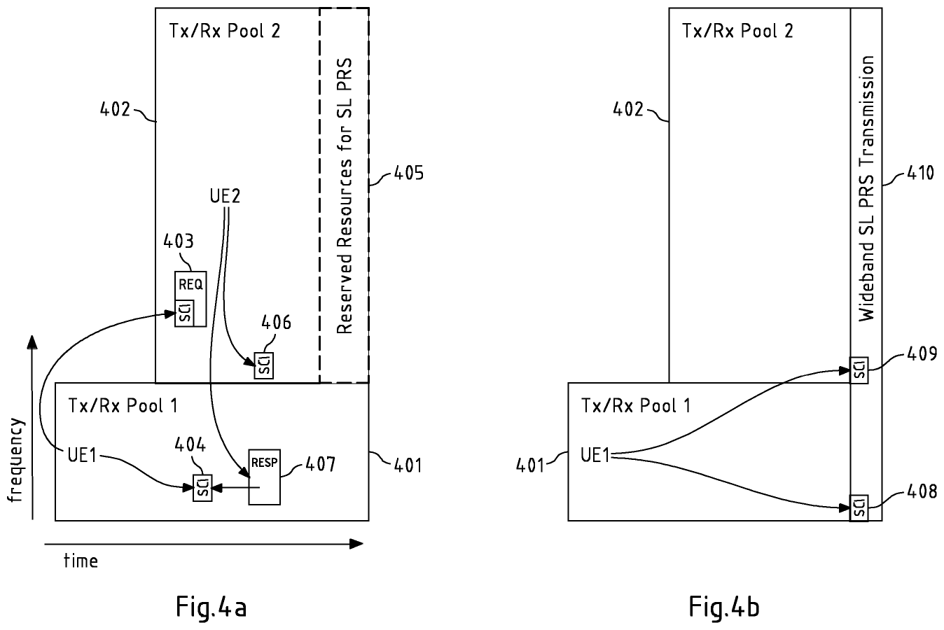

Turning now to FIGS. 4a, b showing sidelink resource pools (in the following also referred to as resource pools or simply pools) of a first and second UE in a time frequency diagram an example embodiment of the different aspects will be illustrated and described below.

As illustrated, there are two sidelink resource pools configured for different UEs in the time frequency diagram. A first sidelink resource pool Tx/Rx Pool 1 401 is configured for a first (or requesting) UE and a second sidelink resource pool Tx/Rx Pool 2 402 is configured for a second (or responding) UE.

The network will indicate to the first UE (and generally to all UEs configured with the respective sidelink resource pool) a list of resource pools configured for all UEs (e.g. served by certain base stations an/or in certain region, for instance).

The first UE configured with the first SL resource pool wants to transmit a wideband SL PRS. The first UE transmits a requests REQ 403 in the second sidelink resource pool 402 so that it is received by the second UE which is configured with the second SL resource pool 402 (and generally in multiple second resource pools different from the first pool and thus to multiple second UEs) in order to reserve resources in the respective second pools for transmitting the SL PRS.

In case there is an overlap between the first sidelink resource pool 401 and the second sidelink resource pool 402 in time/frequency, the first UE may preferably use this overlapping part to transmit the request, so as to avoid any resource collisions since the first UE already monitors this common part of the resource pools. However, in case there is no overlap, as illustrated in FIG. 4a, the first UE transmits the request in the second sidelink resource pool 402. Yet, the first UE does not necessarily monitor the second resource pool for resource selection beforehand but instead it can randomly select the resources in the second pool.

As illustrated in FIG. 4, the first UE sends the request by transmitting a control message, such as sidelink control information, SCI. Here, the SCI itself contains a field indicating the request, without having an associated data payload, hence not indicating any reserved resources in the transmitted pool. However, in an alternative, the request may be indicated within the data payload associated with the SCI.

The request message for the resource reservation for the SL PRS may indicate the amount of SL time/frequency resources to be reserved and/or specific SL time/frequency resources to be reserved. Optionally, the request message may indicate resources reserved by the first UE in the first sidelink resource pool in order for the second UEs to respond to the request on these resources, as well as the transmission parameters (such as the modulation coding scheme, MCS) for the second UE to transmit its respond in these resources. In this case, as illustrated in FIG. 4a, the first UE sends SCI 404 in the first sidelink resource pool 401 to indicate the reserved resources (that will be used by second UE to respond), in order to avoid other UEs in first pool 401 to select these resources.

The second UE receiving such a request then makes a resource reservation 405 in the second sidelink resource pool 402 for SL PRS transmission based on its sensing history. The second UE makes the resource reservation 405 after an expiry of a random timer, by sending a SCI 406 in second pool 402. The SCI 406 serves two purposes: It avoids legacy (and all other) UEs to select reserved resources for SL PRS, hence avoiding resource collisions. Further, the SCI 406 lets the other UEs in second pool 402 know that it is responding to the first UE, so that the other UEs should back off from doing the same in the second resource pool 402. Together with the random timer, this avoids multiple second UEs reserving the resources for the same request. Other UEs in second pool 402 can transmit an acknowledgement to the second UE indicating that they will not respond to the request (e.g. over the PSFCH resources associated with the SCI, as described below).

The second UE then transmits a response RESP 407 to the first UE's request. Generally, the response message 407 contains may contain an ACK or NACK, in case the first UE specifically requested resources or it may contain a set of reserved resources in second pool (e.g. in case the first UE did not request specific resources).

If there is an overlap between first and second pools in time and frequency, the second UE may use this overlapping part to transmit the response 407, so as to avoid any resource collisions since it already monitors this common part of the resource pools.

However, as illustrated in FIG. 4a, if there is no overlap and if the first UE has indicated resources it reserved in first pool 401 for the second UE to respond, second UE transmits the response 407 in the first pool 401. In case of an ACK/NACK type of response, the second UE can use the PSFCH resources associated with the SCI 404 sent by the first UE in the first pool 401. Alternatively, the second UE can use the associated payload with this SCI 404 to respond. In case the second UE changes transmission parameters (such as an MCS value different than indicated in the SCI 404 sent by first UE in the first pool for the resource reservation), the second UE sends a new SCI associated with the RESP message.

However, if the first UE has not indicated any reserved resources for the response, the second UE transmits the response in second pool based on sensing. In this case, the first UE starts monitoring the second resource pool 402 after sending the request 403 to receive corresponding response. In case of an ACK/NACK type of response, the second UE may use the PSFCH resources associated with the SCI of the request message 403 sent by the first UE in the second pool 403. Alternatively, the second UE may also create a new SL transmission to respond.

Turning now to FIG. 4b, the first UE, based on the received response 407 from the second UE configured with the second resource pools (and generally from any responses received from UEs configured with different resource pools), determines the final set of time/frequency resources in all pools to transmit a wideband SL PRS and transmits the SL PRS 410 on the determined set of resources.

For this, the first UE transmits multiple staggered SCIs 408, 409, whereby one SCI is transmitted per each resource pool that the wideband SL PRS spans. The staggered SCIs are placed in the same time instance but different sub-channels such that the individual SCI 408, 409 are always placed at the lowest (or any other pre-defined) sub-channel of a resource pools and/or, in case of overlapping resources, the lowest (or any other pre-defined) sub-channel of any overlapping parts of the resource pools.

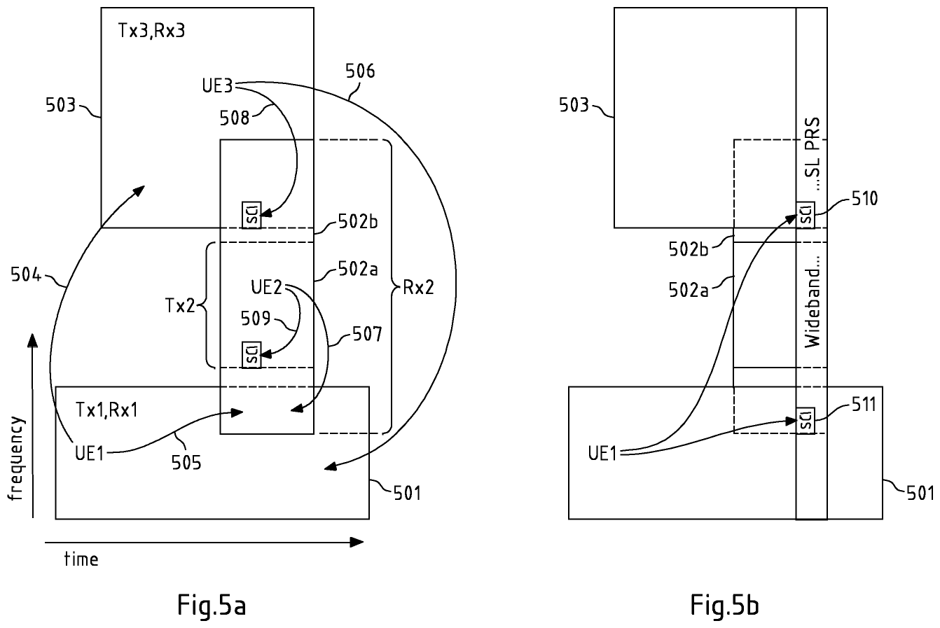

A further exemplary embodiment will now be described in connection with FIG. 5a, b.

The network configures multiple SL resource pools for different UEs. Preferably, the resource pools overlap in frequency and/or time, which allows efficient communications among UEs originally belonging to different resource pools.

In the example illustrated in FIG. 5a, b, the network has configured three different sidelink resource pools Tx1 501, Tx2 502a, and Tx3 503 for SL transmission and three different sidelink resource pools Rx1 501, Rx2 502b, and Rx3 503 for SL reception. The network configures a first UE (UE1) with Tx1 and Rx1, a second UE (UE2) with Tx2 and Rx2, and a further second (or third) UE (UE3) with Tx3 and Rx3.

As can be seen from FIG. 5a, b, Rx2 overlaps with parts of Tx1 and Tx3, which enables UE2 to also monitor transmissions of UEL and UE3. Thus, in contrast to the example given in FIG. 4, there are three UEs with respective different resource pools involved and the resource pools partially overlap.

First, the network indicates all the resource pools configured for the respective UEs at least to the first UEl (but in general all resource pool configurations will be indicated to all of the UEs). This is different from the known approach, where UEs cannot learn about other UEs' pool configuration when transmitted via dedicated signaling. This indication of the resource pools can be sent to the UEs via broadcast message, such as using SIB12, or via dedicated signaling, e.g. a RRCReconfiguration message, or unsolicited or upon UE request, e.g. when UE wants to transmit a wideband SL PRS.

Optionally, the network may indicate the overlapping parts of the resource pools to the UEs, e.g., via SIBs. Alternatively, the UEs can determine resource pool overlaps by analysing the configuration received from the network.

To avoid the problem that different gNBs may configure the resource pools differently, thus avoiding communication and coordination among UEs configured by different gNBs, a centralized controller, e.g., at the network edge, can be utilized to coordinate and/or configure resource pools for a set of gNBs, e.g., in a given area.

Such a centralized network controller, e.g. a location management function LMF, may gather resource pool information belonging to different serving gNBs (e.g., via NRPPa or NGAP signaling). Alternatively, the controller, such as an LMF, may also determine the SL resource pool configurations for a set of gNBs. In turn, the controller may in that case inform the UEs and the gNBs about the pool configurations. In order to inform the UEs, this signaling may be done via LPP signaling in case of an LMF or via NGAP+RRC signaling in case of another core network entity. In order to inform the gNBs, the signaling may be done via NRPPa or a NGAP protocol.

Alternatively, or in addition, neighboring gNBs can coordinate among themselves, e.g., via the Xn interface, to configure the same SL resource pools, or collect each other's resource pool information and share this with the UEs that they serve. For instance, one serving gNB announces resource pools that are configured for a set of neighboring gNBs.

The network can further configure validity criteria associated with the resource pools, e.g., based on or pertaining to a certain area (e.g., set of gNBs), time, distance, etc. This allows common pool configuration in e.g. a certain area, time or distance, so that pool information received from one gNB is also valid in neighboring ones. In this way, the UEs can seamlessly coordinate with each other for SL PRS transmission, e.g. make use of overlapping pools.

We now consider the case that the first UE1 would like to transmit wideband SL PRS optimally spanning across multiple resource pools. Thus, UE1 sends a request message REQ to other UEs in these pools, preferably by using the overlapping parts of the resource pools.

More specifically, in the example of FIG. 5a, UE1 would like to transmit wideband SL PRS across the multiple resource pools Rx1, Rx2, Rx3. To this end, as illustrated in FIG. 5a, the UEl sends a request REQ message (indicated by arrows 504, 505) in these pools 502b, 503, yet preferably making the use of overlapping parts of resource pools to communicate with UEs. In this case UE1 utilizes the overlapping part of Rx2 with Tx1 to send its request in that pool. If there are no overlapping parts between the resource pools of UEs (e.g. as between UEl and UE3 in FIG. 5a), the request message is sent to corresponding non-shared pools.

The request message may indicate a request for SL resource recommendation from other UEs, e.g., by indicating the amount required resources. Additionally or alternatively, the request message indicates a request for whether certain sidelink resource(s) (e.g., subchannel X, slot Y) free or not. Additionally or alternatively, the request message indicates the criticality level of the request by transmitting the reason for bandwidth extension (e.g., reason of transmitting wideband SL PRS, such as due to high accuracy requirement). Additionally or alternatively, the request message indicates which or how many UEs in the corresponding pool can respond.

The following two alternatives for the UEs in other pools to respond to request message are considered.

In the first alternative, the requesting UE reserves SL resources in its own pool, for the UEs in other pools to respond using these resources. In that case the request message indicates the resource pool as well as the reserved resources for the UEs in the other pools to respond. For instance, the request sent by the first UE1 indicates Tx1/Rx1 and any reserved resources therein for UEs utilizing other pools to respond.

In the second alternative, the requesting UE does not reserve any SL resource in its first sidelink resource pool, and starts monitoring corresponding second pools for the response of respective UEs configured with these second pools after sending the request. For instance, UE1 monitors resource pool Tx3 where UE3 will transmit its response

For instance, the network could configure and indicate to UEs which of the above alternatives are allowed. Alternatively, it can be left to the requesting UE's implementation. For instance, a UE may respond using reserved resources in requesting UE's pool, if so indicated by the requesting UE, and otherwise a UE may use its own pool to respond.

The UEs in other pools (UE2, UE3) reserve respective SL resources in their own pool(s) for the requesting UE (UE1) to transmit a wideband SL PRS and respond to the requesting UE with a respective response message RESP 506, 507 that indicates the reserved resources or provides an ACK/NACK for the requested resources by the requesting UE.

As indicated by arrows 508, 509, the respective responding UE also transmits a legacy SL SCI in its own resource pool to let the other UEs (including legacy UEs) be aware of the resource reservation for the SL PRS transmission, hence avoid selecting these resources for their own SL transmissions.

To avoid that all second UEs in a given resource pool respond at the same time, the second UEs may start taking action after a random timer and only then send the above-mentioned SCI 508, 509 for reserving the resources. All other second UEs stop their action once they receive the above-mentioned SCI 508, 509. For instance, a MAC CE can indicate that the SCI is intended to stop other UEs' actions that are non-legacy. Optionally, the other UEs to be stopped may also send an ACK or NACK to the UE sending the SCI 508, 509 indicating that they will not respond to the request as well. This ACK or NACK can be sent using PSFCH resources associated with the legacy SCI 508, 509 sent by the other UEs, or as a dedicated SL transmission.

As described above, the respective second UEs (UE2, UE3) may send the response message RESP 506, 507 using the overlapping parts of the resource pool(s) if available (illustrated for the UE2 response 507 in FIG. 5a). Alternatively they may respond using the reserved resources by the requesting UE in the first resource pool (the case of above alternative 1 and illustrated for the response 506 of the UE3 in FIG. 5a). As a further alternative responding second UEs may use their own pools (the case of above alternative 2).

In case of an ACK/NACK-type response message, the UE may be silent in case of an ACK resp. and only NACKs are sent. Thus, in that scenario the second UE may not send a response and the first UE may not receive a response, but the first UE nevertheless knows that the resources in the second sidelink resource pool were reserved and be used for the SL PRS transmission.

In case the requesting UE is not aware of any other resource pools that other UEs are configured with (e.g. say, in the example in FIG. 5a, the first US (UE1) is not aware of a separate resource pool “Rx4” that UE3 is configured with—not shown in the figure), the responding UEs may also indicate the resource pool configuration of that respective pool (e.g. UE3 responds to UE1 that certain resources are free in Rx4, and provides the resource pool configuration of Rx4, e.g. indicating its sub-channel and slot configuration and any further required resource pool information).

Based on the response messages it receives (506, 507 in FIG. 5a), the requesting first UE1 determines SL resources in multiple pools to transmit the wideband SL PRS. The requesting first UE1 indicates the scheduled SL resources across multiple pools for transmitting the SL PRS to the other UEs via control messages 510, 511 (e.g. SCI) associated with the wideband SL PRS (as illustrated in FIG. 3).

Here, each SCI 510, 511 is transmitted using the first (or any other pre-defined) sub-channel of the overlapping parts of two overlapping resource pools and/or the first (or any other pre-defined) sub-channel of a (non-overlapping) resource pool.

UEs in different pools that are interested in receiving SL PRS decode the control message and receive the associated wideband SL PRS across multiple pools for positioning measurements.

In the following further examples and embodiments are described which may be combined with the exemplary embodiment and aspects describe herein and according to which the exemplary embodiment and aspects may be modified.

The request message REQ and response message RESP may be sent in a broadcast fashion, such that all UEs in an area are able to receive the message.

While the above primarily considered NR SL resource allocation mode 1, in an example, the request message can be sent based on NR SL resource allocation mode 2 (or LTE SL mode 4) including random resource selection or via another listen-before-talk procedure. In another example, the request message could be sent via another contention-based method, such as by random resource selection, so that the requesting first UE does not need to monitor multiple resource pools prior to its request, which may create large power consumption.

In an example, a UE may propagate the first UE's request and/or control messages to account for wider hearabillity of these messages. Specifically, UEs forward requesting UEls request message or SCI control message to other UEs in their neighborhood, e.g. via broadcast. This is to avoid any hidden node problems, and make different UEs across different resource pools and/or proximity to be aware of request or transmission of SL PRS. Also, this ensures that there is no collision with resource aggregation requested by relatively far reaching UEs which were not able to receive the REQ message at first stage.

In an example, the request message indicates the priority of the request. This priority value may be accompanied and/or associated with a reason for sending out such request, e.g., the reason indicates a need of requesting UE's to increase the used bandwidth or resource.

In an example, the ACK response is implicit, i.e. UEs do not send a response message if they observe the requested resource by the requesting UE to be free, whereas they response with a NACK message in case of expected resource collisions.

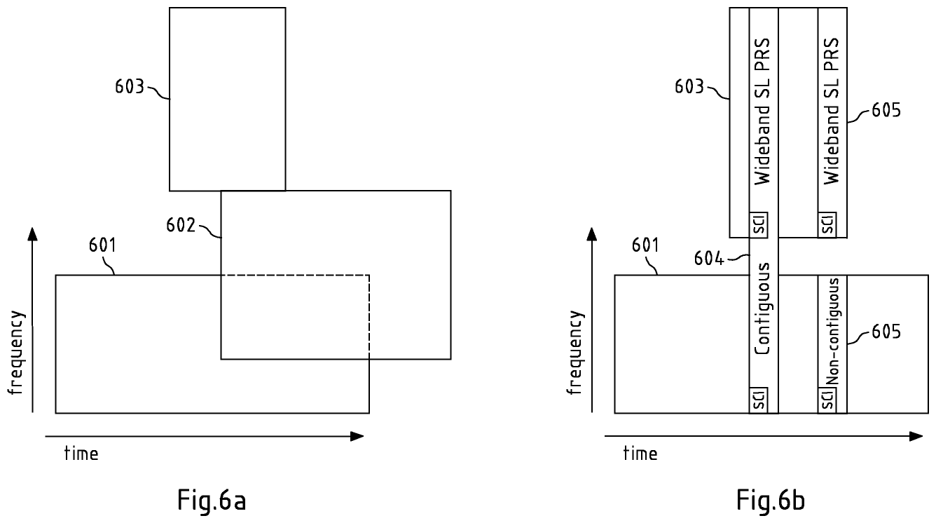

In an example, the resource pools can be (pre-) configured contiguously or non-contiguously over time and/or frequency. This is illustrated in FIG. 6a for a contiguously configured resource pools 601, 602, 603 in the time frequency domain and in FIG. 6b for non-contiguously configured resource pools 601, 603 in the time frequency domain. In case of non-contiguous resource pools, the network may determine whether resources outside the configured pools (i.e., resources within the gaps between the pools or above or below the pool) can be utilized for transmitting a wideband SL PRS. Accordingly, the transmission of a SL PRS might be contiguous or non-contiguous over the frequency domain, as illustrated in FIG. 6 for the contiguous wideband SL PRS 604 and the non-contiguous wideband SL PRS 605. Configuration of SL PRS (e.g., pattern of time/frequency resources) would then need to match the size of the allowed resources as well as the the gaps between the RPs.

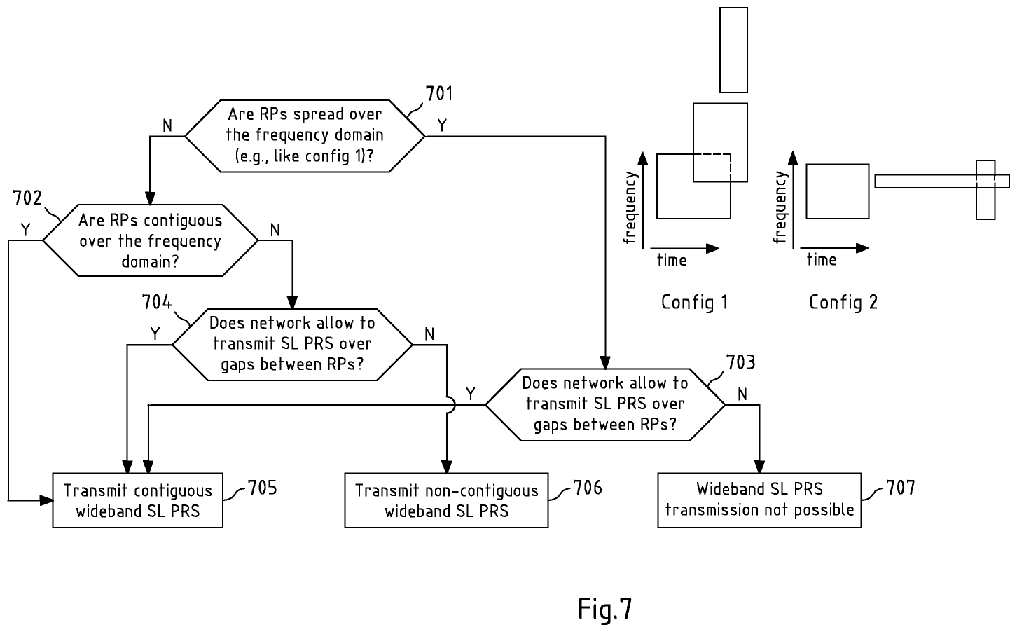

Based on the configuration of available resource pools provided by the network, the first UE can follow a decision tree, for instance as given in FIG. 7 to determine how to transmit the wideband SL PRS and how to configure the SL PRS pattern and resources accordingly.

First, it may be determined whether the resource pools are spread substantially over the carrier bandwidth or a certain frequency domain (action 701).

If the resource pools are spread substantially over the carrier bandwidth or a certain frequency domain (e.g. as shown in Configuration 1 of FIG. 7), it may be determined whether the resource pools are configured or arranged contiguously over the frequency domain (action 702). If the resource pools are configured or arranged contiguously over the frequency domain, a contiguous wideband SL PRS may be transmitted (action 705).

If the resource pools are configured or arranged non-contiguously over the frequency domain, it may be considered whether the network allows transmission of SL PRS outside of the configured resource pools (action 704). If the network allows transmission of SL PRS outside of the configured resource pools, nevertheless a contiguous wideband SL PRS may be transmitted (action 705), e.g. as illustrated with the SL PRS 604 in FIG. 6b. If the network does not allow transmission of SL PRS outside of the configured resource pools, a non-contiguous wideband SL PRS may be transmitted (action 706), e.g. as illustrated with the SL PRS 605 in FIG. 6b.

In case the resource pools are not spread substantially over the carrier bandwidth or a certain frequency domain, it may also be considered whether the network allows transmission of SL PRS outside of the configured resource pools (action 705). If the network allows transmission of SL PRS outside of the configured resource pools, nevertheless a contiguous wideband SL PRS may be transmitted (action 705). If the network does not allow transmission of SL PRS outside of the configured resource pools, a wideband SL PRS may not be transmitted (action 707), as it is not possible to cover substantially the desired bandwidth or frequency domain contiguously or non-contiguously.

In some embodiments, instead of resource pools, UEs may transmit/receive SL PRS across bandwidth parts, frequency bands, or carriers, such as if they are configured with the same numerology. Accordingly, in the disclosed exemplary aspects and examples the term “resource pool” may be replaced with the term “bandwidth part”, “frequency band”, or “carriers”.

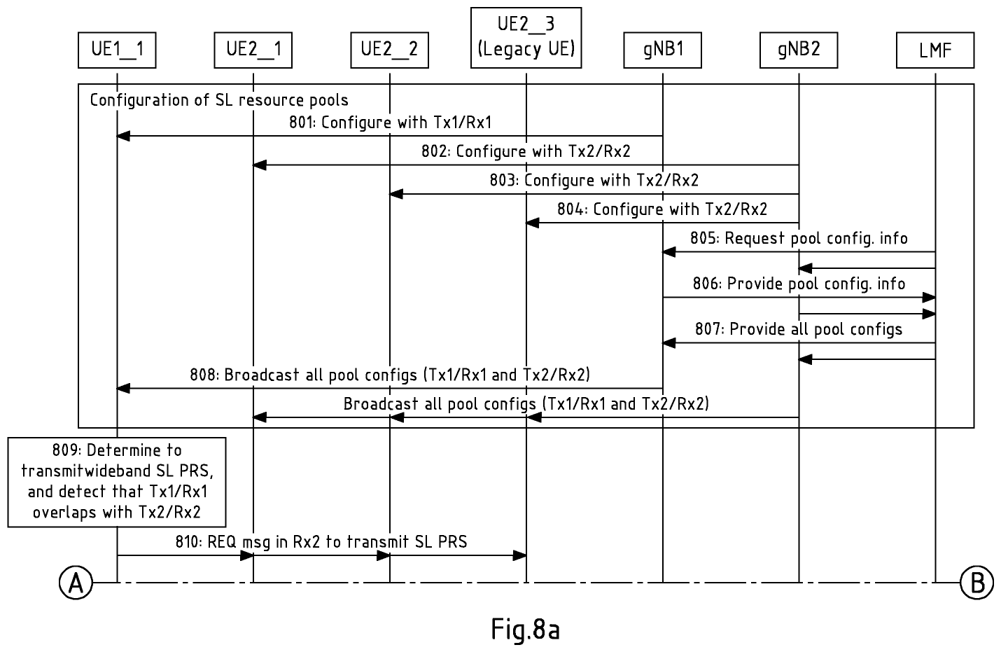

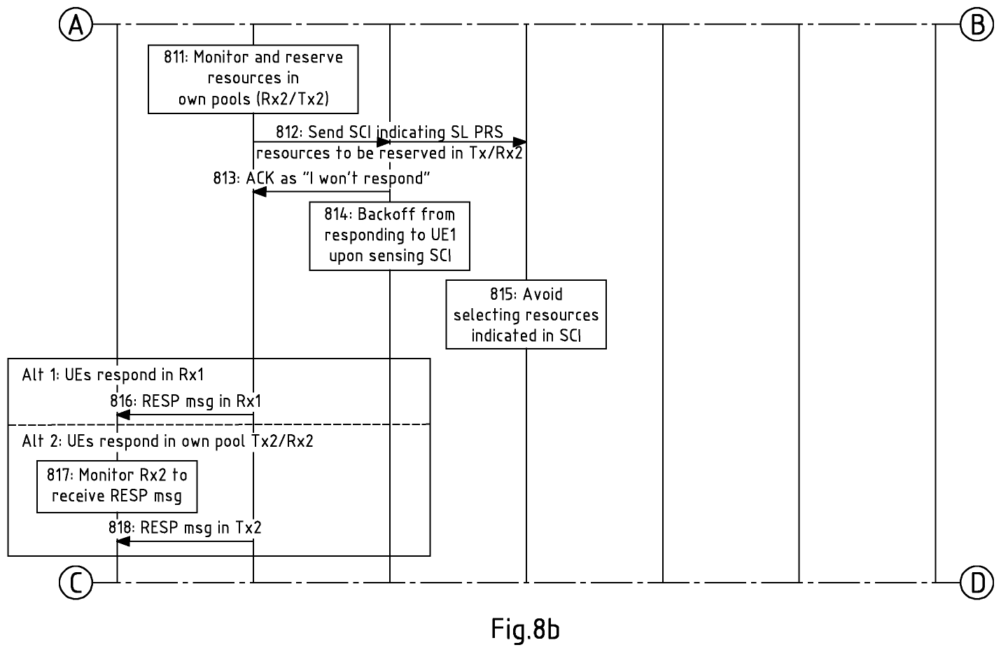

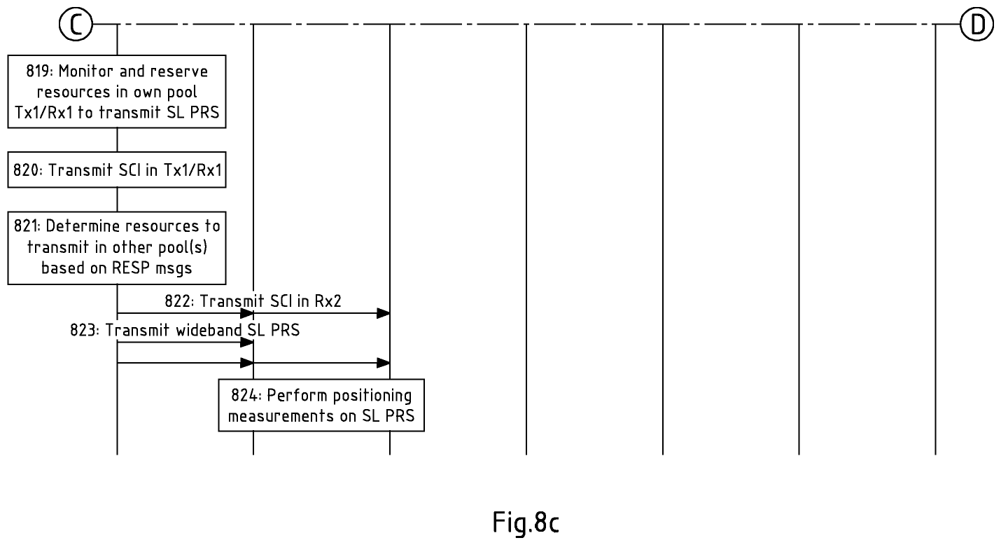

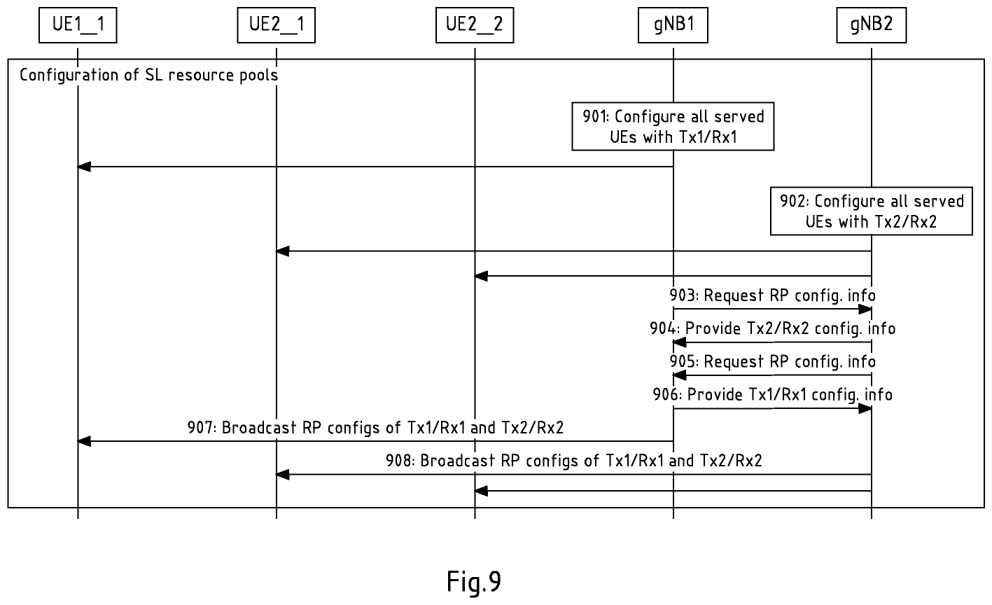

In the following, the signaling flow will be illustrated with reference to the signaling flow charts of FIGS. 8a, b, c and FIG. 9.

In the scenarios of FIGS. 8a, b, c and 9, UE1_1 (as an example of a first terminal device) is served by gNB1, and UE2_1, UE2_2 (as examples of second terminal devices), and UE2_3 are served by gNB2. UE2_3 is a legacy UE that may not support the approach described herein, i.e. it may not able to participate in the described inter-pool coordination of resource allocation for a wideband SL PRS transmission.

Turning now to FIGS. 8a, b, c, a central network coordinating entity, in this case a LMF, collects resource pool configurations of different gNBs that it controls. In turn, the entity provides all resource poo configurations to the gNBs. The gNBs provide the same configuration information of all resource pools to all UEs they serve, such as via broadcast message.

In more detail, a configuration of the SL resource pools is performed. For this, UE1_1 is configured with the first resource pools Tx1/Rx1 (action 801) by gNB1, UE2_1, UE2_2 and UE2_3 (legacy UE) are configured with the second resource pools Tx2/Rx2 by gNB2 (actions 802, 803, 804). The LMF requests information on the respective SL resource pool configurations from the gNB1 and gNB2 (action 805), gNB1 and gNB2 provide the requested information to the LMF (action 806). In turn, the LMF can provide each gNB with the configured SL resource pools of the respective other gNBs (action 807). Each gNB can then provide (e.g. broadcast) all SL resource pool configurations to the UEs served by the respective gNB (action 808).

UE1_1 then determines that a wideband SL PRS is to be transmitted and detects that the (own) resource pools Tx1/Rx1 overlaps with the second resource pools Tx2/Rx2 (action 809). UE1_1 then transmits a request message in the second resource pool Rx2 to transmit a SL PRS (action 810). UE2_1 monitors this resource pool Rx2 and reserves resources in its own resource pools (RX2/Tx2) (action 811). While UE2_2 also monitors the resource pool Rx2, and may also have received the request, the timer of UE2_1 has expired earlier. UE2_1 then sends a SCI indicating the SL PRS resources to be reserved in Tx2/Rx2 to the other UEs served by gNB2 (i.e. UE2_2 and UE2_3) (action 812). UE2_2 transmits an acknowledgment to UE2_1 indicating or confirming that UE2_2 will not respond to the request (action 813). Accordingly, UE2_2 will back off from responding to the request of UEl upon sensing the SCI of UE2_1 (action 814). As the legacy UE2_3 has also received the SCI transmitted by UE2_1 in action 812, it will also avoid selecting resources indicated in the SCI (action 815).

UE2_1 then sends a response message in the resources of the sidelink resource pool Rx1 associated with UE1_1 (action 816). Alternatively, for cases where UE2_1 is not provided with any reserved resources in resource pool Rx1, UE1_1 monitors the SL resource pool Tx2 of UE2_1 (action 817) and UE2_1 sends the response message in its own resource pool Tx2 (action 818).

UE1_1 monitors the resources in its own pool Tx1/Rx1 (action 819) and transmits a SCI in Tx1/Rx1 (action 820). UE1_1 also determines the resources to transmit the SL PRS in other resource pool(s) based on the received response message(s) (action 821) and transmits SCI in determined resource pools, here in Rx2 (action 822). UE1_1 can thus transmit a wideband SL PRS (action 823). The wideband SL PRS will be received not only be UEs in the first SL resource pool Tx1/Rx1 but also be devices in the second SL resource pool Tx2/Rx2 (such as UE2_1, UE2_2). UE2_1 and UE2_2 can thus perform positioning measurements on SL PRS (action 824).

Turning now to FIG. 9 an alternative way (compared to actions 801-808 of FIGS. 8a, b, c) of configuring the SL resource pools is described. In this case there is no central coordinating entity and the gNBs coordinate among themselves to obtain each other's resource pool configuration information. In turn, they share the all collected resource pool information belonging to different gNBs with the UEs they serve, such as via broadcast message.

That is, more specifically, UE1_1 is configured with the first resource pools Tx1/Rx1 by gNB1 (action 901), UE2_1, UE2_2 are configured with the second resource pools Tx2/Rx2 by gNB2 (action 902). gNB1 requests information on the respective SL resource pool configurations from gNB2 (action 903). gNB2 provides the requested information to gNB1 (action 904). Likewise, gNB2 requests information on the respective SL resource pool configurations from gNB1 (action 905) and gNB1 provides the requested information to gNB2 (action 906). Each gNB can then provide (e.g. broadcast) all SL resource pool configurations to the UEs served by the respective gNB (actions 907, 908).

The rest of the steps may be the same as described with respect to FIGS. 8a, b, c.

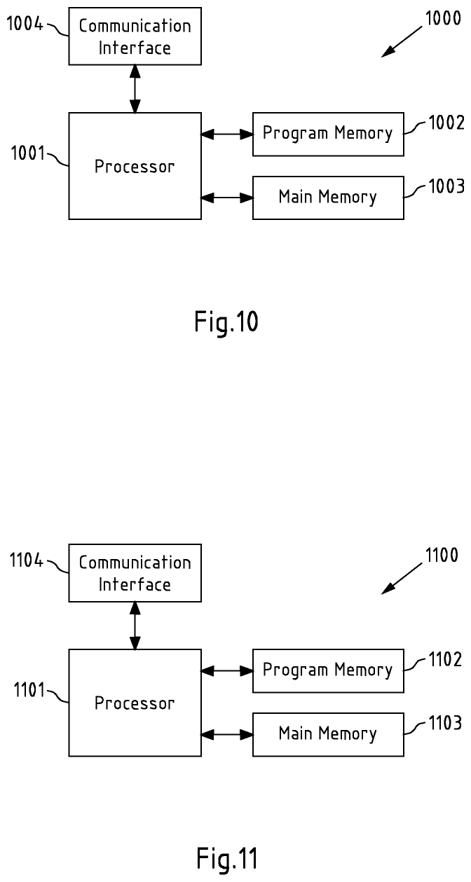

Turning now to FIG. 10, there is shown a block diagram of an exemplary embodiment of a first or second terminal device or UE 1000 according to the present disclosure. For example, UE 1000 may be one of a smartphone, a tablet computer, a notebook computer, a smart watch, a smart band, an IoT device or a vehicle or a part thereof.

UE 1000 comprises a processor 1001. Processor 1001 may represent a single processor or two or more processors, which are for instance at least partially coupled, for instance via a bus. Processor 1001 executes a program code stored in program memory 1002 (for instance program code causing mobile device 1000 in connection with base station 1000 to perform one or more of the embodiments of a method according to the present disclosure or parts thereof, when executed on processor 1001, and interfaces with a main memory 1003. Program memory 1002 may also contain an operating system for processor 1001. Some or all of memories 1002 and 1003 may also be included into processor 1001.

One of or both of a main memory and a program memory of a processor (e.g. program memory 1002 and main memory 1003) could be fixedly connected to the processor (e.g. processor 1001) or at least partially removable from the processor, for instance in the form of a memory card or stick.

A program memory (e.g. program memory 1002) may for instance be a non-volatile memory. It may for instance be a FLASH memory (or a part thereof), any of a ROM, PROM, EPROM, MRAM or a FeRAM (or a part thereof) or a hard disc (or a part thereof), to name but a few examples. For example, a program memory may for instance comprise a first memory section that is fixedly installed, and a second memory section that is removable from, for instance in the form of a removable SD memory card.

A main memory (e.g. main memory 1003) may for instance be a volatile memory. It may for instance be a DRAM memory, to give non-limiting example. It may for instance be used as a working memory for processor 1001 when executing an operating system, an application, a program, and/or the like.

Processor 1001 further controls a communication interface 1104 (e.g. radio interface) configured to receive and/or transmit data and/or information. For instance, communication interface 1004 may be configured to transmit and/or receive radio signals from a radio node, such as a base station, in particular as described herein. It is to be understood that any computer program code based processing required for receiving and/or evaluating radio signals may be stored in an own memory of communication interface 1004 and executed by an own processor of communication interface 1004 and/or it may be stored for example in memory 1003 and executed for example by processor 1001.

Communication interface 1004 may in particular be configured to communicate according to a cellular communication system like a 2G/3G/4G/5G or future generation cellular communication system. Terminal device 1000 may use radio interface 1004 to communicate with a base station.

For example, the communication interface 1004 may further comprise a BLE and/or Bluetooth radio interface including a BLE transmitter, receiver or transceiver. For example, radio interface 1104 may additionally or alternatively comprise a WLAN radio interface including at least a WLAN transmitter, receiver or transceiver.

The components 1002 to 1004 of terminal device 1000 may for instance be connected with processor 1001 by means of one or more serial and/or parallel busses.

It is to be understood that terminal device 1000 may comprise various other components. For example, terminal device 1000 may optionally comprise a user interface (e.g. a touch-sensitive display, a keyboard, a touchpad, a display, etc.).

FIG. 11 is a block diagram of an exemplary embodiment of a network entity, such as a base station or gNB. For instance, network device 1100 may be configured for scheduling and/or transmitting signals to the UE, as described above.

Network device 1100 comprises a processor 1101. Processor 1101 may represent a single processor or two or more processors, which are for instance at least partially coupled, for instance via a bus. Processor 1101 executes a program code stored in program memory 1102 (for instance program code causing network device 1100 to perform alone or together with terminal device 1000 embodiments according to the present disclosure or parts thereof), and interfaces with a main memory 1103.

Program memory 1102 may also comprise an operating system for processor 1101. Some or all of memories 1102 and 1103 may also be included into processor 1101.

Moreover, processor 1101 controls a communication interface 1104 which is for example configured to communicate according to a cellular communication system like a 2G/3G/4G/5G cellular communication system. Communication interface 1104 of apparatus 1100 may be realized by radio heads for instance and may be provided for communication between network device and terminal device.

The components 1102 to 1104 of apparatus 1100 may for instance be connected with processor 1101 by means of one or more serial and/or parallel busses.

It is to be understood that apparatuses 1000, 1100 may comprise various other components.

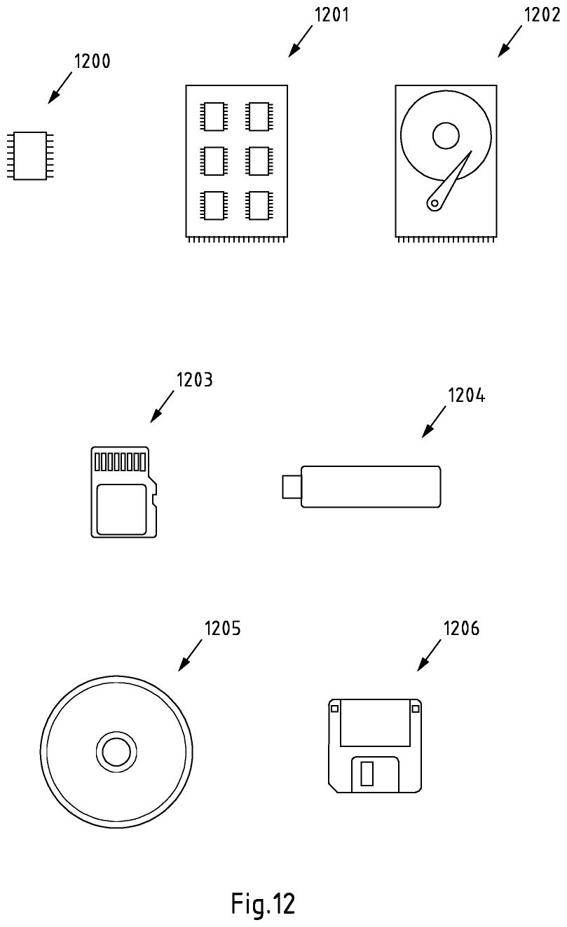

FIG. 12 is a schematic illustration of examples of tangible and non-transitory computer-readable storage media according to the present disclosure that may for instance be used to implement memory 1002 of FIG. 10 or memory 1102 of FIG. 11. To this end, FIG. 12 displays a flash memory 1200, which may for instance be soldered or bonded to a printed circuit board, a solid-state drive 1201 comprising a plurality of memory chips (e.g. Flash memory chips), a magnetic hard drive 1202, a Secure Digital (SD) card 1203, a Universal Serial Bus (USB) memory stick 1204, an optical storage medium 1205 (such as for instance a CD-ROM or DVD) and a magnetic storage medium 1206.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)

(b) combinations of circuits and software (and/or firmware), such as: (i) to a combination of processor(s) or (ii) to sections of processor(s)/software (including digital signal processor(s)), software, and memory(ies) that work together to cause an apparatus, such as a mobile phone, to perform various functions) and

(c) to circuits, such as a microprocessor(s) or a section of a microprocessor(s), that re-quire software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or section of a processor and its (or their) accompanying software and/or firmware. The term ‘circuitry’ also covers, for example, a baseband integrated circuit or applications processor integrated circuit for a mobile phone.

Any of the processors mentioned in this text, in particular but not limited to processors 1001 and 1101 of FIGS. 10 and 11, could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Moreover, any of the actions or steps described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICS, signal processing devices, and other devices.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The wording “A, or B, or C, or a combination thereof” or “at least one of A, B and C” may be understood to be not exhaustive and to include at least the following: (i) A, or (ii) B, or (iii) C, or (iv) A and B, or (v) A and C, or (vi) B and C, or (vii) A and B and C.

It will be understood that the embodiments disclosed herein are only exemplary, and that any feature presented for a particular exemplary embodiment may be used with any aspect of the present disclosure on its own or in combination with any feature presented for the same or another particular exemplary embodiment and/or in combination with any other feature not mentioned. It will further be understood that any feature presented for an example embodiment in a particular category may also be used in a corresponding manner in an example embodiment of any other category.

### REFERENCES

[1] 3GPP TR 38.845 V17.0.0, “Study on scenarios and requirements of in-coverage, partial coverage, and out-of-coverage NR positioning use cases (Release 17)”, September 2021

[2] “System Architecture and Solution Development; High-Accuracy Positioning for C-V2X-5G Automotive Association.” [Online]. Available: https://5gaa.org/news/system-architecture-and-solution-development-high-accuracy-positioning-for-c-v2x/. [Accessed: 12-Nov-2021]

[3] M. H. C. Garcia et al., “A Tutorial on 5G NR V2X Communications,” in IEEE Communications Surveys & Tutorials, vol. 23, no. 3, pp. 1972-2026, thirdquarter 2021, doi: 10.1109/COMST.2021.3057017.

[4] “Carrier Aggregation explained.” [Online]. Available: https://www.3gpp.org/technologies/keywords-acronyms/101-carrier-aggregation-explained.

[5] 3GPP TR 37.985 V16.0.0, “Overall description of Radio Access Network (RAN) aspects for Vehicle-to-everything (V2X) based on LTE and NR (Release 16)”, June 2020

1-24. (canceled)

25. A first terminal device comprising at least one processor and at least one memory including computer program code, the at least one memory and the computer program code configured to, with the at least one processor, cause the first terminal device at least to:
receive resource pool information related to a second sidelink resource pool configured for a second terminal device;
transmit, via sidelink communication, a request to the second terminal device to reserve resources in the second sidelink resource pool for transmission, by the first terminal device, of a sidelink positioning reference signal;
receive, via sidelink communication, a response to the request from the second terminal device; and
based on the response, transmit a sidelink positioning reference signal using resources in the first sidelink resource pool and resources in the second sidelink resource pool.

26. The first terminal device of claim 25, wherein the request is transmitted based on the received resource pool information.

27. The first terminal device of claim 25, wherein the request is transmitted in one or more of the following:
a physical sidelink control channel;
a control information message;
a sidelink control information message;
an information field of a sidelink control information message;
a physical sidelink shared channel;
a data payload associated with a sidelink control information message;
resources overlapping between the first sidelink resource pool and the second sidelink resource pool; or
the second sidelink resource pool.

28. The first terminal device of claim 25, wherein the request comprises one or more of the following:
information representative of an amount of resources in the second sidelink resource pool requested to be reserved;
information representative of resources in the second sidelink resource pool requested to be reserved;
information representative of resources in the first sidelink resource pool reserved by the first terminal device to be used by the second terminal device for responding to the request; or
information representative of transmission parameters to be used by the second terminal device for responding to the request.

29. The first terminal device of claim 25, wherein the first terminal device is further caused to:
reserve resources in the first resource pool to be used by the second terminal device for responding to the request.

30. The first terminal device of claim 25, wherein the first terminal device is further caused to:
determine, based on the response, resources for transmitting the sidelink positioning reference signal.

31. The first terminal device of claim 25, wherein the response includes information regarding the resources in the second sidelink resource pool for transmission, by the first terminal device, of the sidelink positioning reference signal.

32. The first terminal device of claim 31, wherein the response is received in one of the following:
resources overlapping between the first sidelink resource pool and the second sidelink resource pool;
resources in the first sidelink resource pool;
resources in the first sidelink resource pool reserved by the first terminal device to be used by the second terminal device for responding to the request;
resources of a physical sidelink feedback channel associated with a sidelink control information message used by the first terminal device for reserving resources in the first sidelink resource pool;
a data payload associated with a sidelink control information message used by the first terminal device for reserving resources in the first sidelink resource pool;
a data payload associated with a sidelink control information message transmitted by the second terminal device, said sidelink control information message optionally comprising information representative of transmission parameters used by the second terminal device for the response;
resources in the second sidelink resource pool;
resources of a physical sidelink feedback channel associated with a sidelink control information message comprising or associated with the request transmitted by the first terminal device in the second sidelink resource pool; or
a separate sidelink transmission.

33. The first terminal device of claim 25, wherein the response comprises one of the following:
an acknowledgement of resources in the second sidelink resource pool requested to be reserved by the first terminal device with the request;
a negative acknowledgement of resources in the second sidelink resource pool requested to be reserved by the first terminal device with the request; or
information representative of resources in the second sidelink resource pool reserved by the second terminal device for the transmission of the sidelink positioning reference signal.

34. The first terminal device of claim 25, wherein the resource pool information is received from the network, in particular via one of the following:
radio resource control (RRC) signaling;
a broadcast message; or
a system information block (SIB).

35. The first terminal device of claim 25, wherein the first terminal device is further caused to:
receive, from the network, information on overlaps between configured resource pools; and/or
receive, from the network, information on whether a sidelink position reference signal transmission is allowed in resources outside of configured resource pools.

36. The first terminal device of claim 25, wherein, for transmitting the sidelink positioning reference signal, one or more of the following is transmitted by the first terminal device:
multiple control information messages, in particular sidelink control information messages;
multiple control information messages in the same time resource; or
multiple control information messages in different frequency resources.

37. The first terminal device of claim 25, wherein, in case the first sidelink resource pool and the second sidelink resource pool overlap in the time and frequency domain, a control information messages for the sidelink positioning reference signal is transmitted in resources overlapping between the first sidelink resource pool and the second sidelink resource pool.

38. The first terminal device of claim 25, wherein the sidelink positioning reference signal substantially covers the bandwidth of the first sidelink resource pool and the second sidelink resource pool.

39. The first terminal device of claim 25, wherein the sidelink positioning reference signal covers resources in the frequency domain outside of the first and second sidelink resource pools.

40. A second terminal device comprising at least one processor and at least one memory including computer program code, the at least one memory and the computer program code configured to, with the at least one processor, cause the second terminal device at least to:
be configured for sidelink communication in a second sidelink resource pool;
receive, via sidelink communication, from a first terminal device configured for sidelink communication in a first sidelink resource pool, a request to reserve resources in the second sidelink resource pool for transmission, by the first terminal device, of a sidelink positioning reference signal;
transmit, via sidelink communication, to the first terminal device, a response to the request; and
reserve, in response to the request, resources in the second sidelink resource pool for transmission, by the first terminal device, of a sidelink positioning reference signal.

41. The second terminal device of claim 40, wherein the resources in the second sidelink resource pool for transmission, by the first terminal device, of sidelink positioning reference signal are reserved after an expiry of a timer.

42. A network entity comprising at least one processor and at least one memory including computer program code, the at least one memory and the computer program code configured to, with the at least one processor, cause the network entity at least to:
transmit or cause transmitting, to a first terminal device, resource pool information related to sidelink resource pools configured for one or more other terminal devices served by respective other base stations.

43. The network entity of claim 42, wherein the network entity is one of:
a centralized network controller gathering and/or distributing resource pool information related to sidelink resource pools managed by multiple serving base stations; or
a base station configured for coordinating with one or more other base stations with respect to the sidelink resource pools configured or to be configured by the respective base stations.
